(19) United States
(12) Patent Application Publication
(10) Pub. No.: US 2015/0113024 A1
(43) Pub. Date: Apr. 23, 2015

(54) GENERATING SOCIAL GRAPHS USING COINCIDENT GEOLOCATION DATA

(71) Applicant: MASTERCARD INTERNATIONAL INCORPORATED, Purchase, NY (US)

(72) Inventor: Justin X. Howe, Oakdale, NY (US)

(73) Assignee: MASTERCARD INTERNATIONAL INCORPORATED, Purchase, NY (US)

(21) Appl. No.: 14/056,430

(22) Filed: Oct. 17, 2013

(51) Int. Cl. G06F 17/30

(52) U.S. Cl. CPC G06F 17/30241
USPC 707/798

(57) ABSTRACT

The present disclosure provides a method and a system for generating social graphs using coincident geolocation data. In particular, a method is provided in which an entity retrieves information from one or more databases. The information includes geolocation data for a plurality of entities generated over a predetermined period of time. The information is analyzed to determine coincident geolocation information of the entities. The coincident geolocation information is then analyzed to determine social relationships of the entities. One or more social graphs are then generated based on the social relationships of the entities. The social graphs comprise multi-node graphs having edges or connectors linking the nodes. The entities are represented by the nodes. A social relationship between the entities is represented by the edges or connectors linking the nodes. The attributes of the edges or connectors are based upon information describing a characteristic of the relationship.

### BACKGROUND OF THE DISCLOSURE

1. Field of the Disclosure

The present disclosure relates to a method and a system for generating social graphs using coincident geolocation data. In particular, the present disclosure relates to a method and a system for social network analysis of coincident geolocation data corresponding to various aspects of activities of entities.

2. Description of the Related Art

Geolocation data corresponding to various aspects of one's activities is readily available. For example, many users have a Global Positioning System (GPS) associated with their activities in one way or another. Such GPS devices are installed in many automobiles today, either as stand-alone transportable units, or as integrated units positioned in the dashboard of the automobile as purchased. Additionally, many watches and smart phones are now available with embedded GPS receivers and the availability to access a mapping application for providing real-time global positioning and tracking capability.

While it is straightforward to determine the path of a user through the use of GPS, a history of one's whereabouts can also be gleaned from many other sources. Even without a GPS receiver, the location of a cell phone on one's person can be roughly estimated from the regularly timed pings received from the device at a nearest receiver tower. More detailed location data is available when a user activates the cell phone to place a call. Similarly, information about the geolocation history and habits of users may be recorded from various internet and smart phone applications, such as Facebook®, Twitter®, Foursquare®, and other social media applications, including those through which users voluntarily and routinely “check-in” or otherwise publish information of their physical locations at any particular time.

A social graph consists of nodes that represent people or groups with whom an individual is connected comprising connections or edges, representing relationships such as work, friendship, interests, and location.

There are many applications of social graphs, as seen in marketing applications, email spam detection and fraud prevention. With regard to geolocation, there is an assumption that people will be in recurrent proximity if they have relationships.

There is currently no known method or system for generating a social graph directly from geolocation data. Currently, there is no known method or system for analyzing geolocation data to define social networks and relationships for predicting behaviors, such as target advertising.

### SUMMARY OF THE DISCLOSURE

The present disclosure provides a method and a system for generating social graphs using coincident geolocation data. In particular, the present disclosure provides a method and a system for social network analysis using social graphs built from coincident geolocation data.

The present disclosure provides a method and a system for generating a social graph directly from coincident geolocation data. The method and system of the present disclosure make it possible to use a social graph and geolocation data in an anonymized context.

In accordance with this disclosure, a method is provided in which an entity retrieves information from one or more databases. The information includes geolocation data for a plurality of entities generated over a predetermined period of time. The information is analyzed to determine coincident geolocation information of the entities. The coincident geolocation information is then analyzed to determine social relationships of the entities. One or more social graphs are then generated based on the social relationships of the entities.

The one or more social graphs comprise one or more multi-node graphs having edges or connectors linking the nodes. The entities are represented by the nodes. A social relationship between the entities is represented by the edges or connectors linking the nodes. The attributes of the edges or connectors are based upon information describing a characteristic of the relationship.

This disclosure also provides a system that includes one or more databases configured to store information, and a processor. The information includes geolocation data for a plurality of entities generated over a predetermined period of time. The processor is configured to: analyze the information to determine coincident geolocation information of the entities; analyze the coincident geolocation information to determine social relationships of the entities; and generate one or more social graphs based on the social relationships of the entities.

The social graphs of the present disclosure can have many applications, for example, marketing, “influencer” identification, fraud detection (e.g., bust-out fraud), crime prediction, counterterrorism, and the like. As used herein, “influencers” are people who persuade their friends, family and colleagues to follow them when they switch allegiances with companies or merchants (e.g., a mobile phone subscriber of a telecom operator switching to a rival telecom operator).

These and other systems, methods, objects, features, and advantages of the present disclosure will be apparent to those skilled in the art from the following detailed description of the preferred embodiment and the drawings.

### BRIEF DESCRIPTION OF THE DRAWINGS

FIG. 1 is a flow chart illustrating a method for generating social graphs in accordance with exemplary embodiments of this disclosure.

FIG. 2 is a block diagram illustrating illustrates a dataset for the storing, reviewing, and/or analyzing of information used in generating social graphs in accordance with exemplary embodiments.

FIG. 3 illustrates information describing characteristics of a relationship that are used in generating social graphs in accordance with exemplary embodiments.

FIG. 4 illustrates metrics associated with edges or connectors that are used in generating social graphs in accordance with exemplary embodiments.

A component or a feature that is common to more than one figure is indicated with the same reference number in each figure.

### DESCRIPTION OF THE EMBODIMENTS

Embodiments of the present disclosure can now be described more fully hereinafter with reference to the accompanying drawings, in which some, but not all, embodiments of the disclosure are shown. Indeed, the disclosure can be embodied in many different forms and should not be construed as limited to the embodiments set forth herein. Rather, these embodiments are provided so that this disclosure can satisfy applicable legal requirements. Like numbers refer to like elements throughout.

As used herein, social graphs include both voting graphs and relationship graphs. The relationship graph is a subset of the voting graph. Only edges with cumulative vote weightings exceeding the vote threshold are included in the relationship graph.

As used herein, entities or users can include one or more persons, organizations, businesses, institutions and/or other entities, including but not limited to, financial institutions, and services providers, that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

Assuming that entities with social relationships often are in recurrent proximity makes it possible to define a social relationship between two entities. More specifically, a social relationship is implied whenever two entities are in recurrent proximity over a predetermined period of time.

Recurrent proximity can be defined as “occurring often or repeatedly” that implies that two individuals were repeatedly standing next to each other, traveling together, or otherwise in closeness, immediacy or nearness within a threshold distance. With regard to threshold distances, distances within the same domicile should always be considered in proximity, while outdoor distances greater than 20 feet should not be considered in proximity. It is noted that existing GPS installations are only accurate to about a 30 foot radius, while next generation of the service is expected to be accurate to about a 5 foot radius.

While a large number of ‘relationships’ will be defined by such a method, it is understood that a voting graph and a relationship graph are preferably constructed from recurring coincidents, preferably identified at a variety of geolocations and times of day. In this fashion, the large number of encounters between entities strengthens the quality of the voting graph and the relationship graph.

This can take the form of each “coincidence” being associated with two entities, the geolocation of the entities, the frequency of the geolocation, the number of geolocations, the date and time that the entities were at the geolocation, and the duration that the entities were at the geolocation. This can take the form of an array for each edge comprising the day of month, weekday, and time of day information. For example, each coincidence can be represented as a 1 in each element of the array corresponding to the appropriate day and time. This can alternatively take the form of an addendum listing each coincidence and it's characteristics such as duration, time of day, geolocation, and density of transmitters in the vicinity.

The voting graph and the relationship graph can be defined as the accumulation of the coincidence data, with the frequency or density of recurrent proximity ascribed as an attribute of the edge or edges of the voting graph and the relationship graph. See, for example, http://en.wikipedia.org/wiki/Directed_graph, for a description of directed graphs, or set of nodes connected by edges, where the edges have a direction associated with them. In accordance with this disclosure, the voting graph and the relationship graph have at least one edge connecting two entities and at most two edges connecting the two entities (assuming that the direction of relationship is recorded). Furthermore, attributes may be associated to those edges and can be weighted inversely to the density of transmitters. In this fashion, each relationship can be weighted inversely to the number of people also in proximity (e.g., a train, subway, or Starbucks®). For purposes of this disclosure, the voting graph and the relationship graph are data structures.

The term “geolocation” as used herein refers to an entity's location as collected from a cell phone tower or beacon, GPS, or other position indicators, and can include GPS coordinates, street address, an IP address, geo-stamps on digital photographs, smartphone check-in or other data, and other location data provided as a result, for example, of a telecommunications or on-line activity of a user.

Votes can be generated for a given pair of entities (aka transmitters) with a numeric value determined by the length of time the entities were in geographic proximity, the number of unique geolocations at which coincidences occurred, the density of transmitters at the time of coincidence, or temporal characteristics. This compression could alternatively take the form of an interval tree (http://en.wikipedia.org/wiki/Interval_tree) as known in the art.

The voting graphs, as described herein, can be constructed to include a single node for each unique entity, and an edge for every relationship with another entity. The relationship graphs, as described herein, can be constructed to include a single node for each unique entity, and an edge for every relationship with another entity with cumulative vote weightings exceeding a predefined vote threshold. In this fashion, a voting graph and relationship graph of all coincident geolocation data made by entities can be constructed.

The steps and/or actions of a method described in connection with the exemplary embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, so that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It can be understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, so that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, so that the instructions stored in the computer readable memory produce an article of manufacture including instruction means which implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the disclosure.

In accordance with the method of this disclosure, information that is stored in one or more databases can be retrieved (e.g., by a processor). The information can contain, for example, information including geolocation or geotemporal data corresponding to various aspects of activities of entities. Other databases can also be available that include billing activities attributable to the financial transaction processing entity (e.g., a payment card company) and purchasing and payment activities attributable to payment cardholders. Illustrative information can include, for example, financial (e.g., billing statements and payments), purchasing information, demographic (e.g., age and gender), geographic (e.g., zip code and state or country of residence), and the like.

Geotemporal or geolocation data is temporal and geolocation data (cell phone tower location, IP address, GPS coordinates) that is sent, usually along with other information, from a communications device a user is accessing (such as, a cell phone tower, computer, GPS device) to perform a certain activity at a particular time.

It is understood that, depending on applicable law, social network and telephone users may need to be notified of the processes by which various information is obtained, as described herein, by their mobile network operator. In certain cases, their specific consent may be needed to include their information in the relevant tables described herein.

In one embodiment, geolocation information is obtained from users of cell phones from “ping” data which includes geotemporal data. Optionally, call record data can also be retrieved from records of a cellular telephone usage database of a telecommunications service provider.

It is assumed herein that an entity travels with his or her cell phone. As is known among those of ordinary skill in the art, a cell phone “pings” a nearest cell tower at regular intervals, for example, about every minute. A telecommunications service provider can store this information for a period of time, in some cases, up to about forty-eight (48) hours. The ping data includes a user ID associated with the cell phone from which the ping originates, and a geolocation, for example, a cell phone tower ID, which also corresponds to a georegion, or broadcast area, which is known to contain the entity with the cell phone. If a call is made or GPS coordinates requested, however, the telecom provider will have more precise positional data, which is stored in call detail records.

In accordance with one embodiment of a method of the present disclosure, the ping data is retrieved for a plurality of users/subscribers of a telecommunications service provider over a predetermined period of time, for example, one week, one month, or one year. The retrieved ping data is in time sequential order. The ping data is separated into tables, each table corresponding to a different geolocation. The ping data records are then reduced or compressed. The compression of ping data can be performed as the ping data is received from the cell phones, by the service provider, for example, or after retrieval of stored ping data from the service provider. One method of compression being the elimination of all ping data for the same transmitter in the same geography in a continuous time period which is not the earliest or latest continuous record.

For example, a ‘distance threshold’ A is defined as the maximum distance two transmitters can be from each other and still be considered to have a coincidence. A ‘coincidence’ is defined as two different transmitters being within A of each other for at least a time period τ (tau) (e.g., tau=10 minutes). It is assumed that this metric also accommodates altitude/elevation information to prevent everyone in the same apartment building from being linked, and that presence on different floors can be distinguished. A ‘horizon’ is the length of time over which the vote weights are examined. (e.g., 1 month or 1 year). A ‘relationship’ is a pair of transmitters deemed to know each other based on a sufficient cumulative vote weighting which exceeds a vote threshold. A ‘vote threshold’ is a numeric value, such that any cumulative vote weightings greater than this value are assumed to imply a social relationship exists between the identified customers. A ‘density’ (D) is defined as the number of transmitters within A of a transmitter during time period tau.

Each entity in a given geolocation/table, is checked to see if the entity remained in that location longer than tau. If the entity was not, then the entity is removed from that table. Then for each entity with time greater than tau₁ in that geolocation, every transmitter with time greater than tau₂ in that same geolocation (time within or overlapping tau₁) and within the distance threshold delta is ascribed votes equal to the overlap of tau₁, tau₂.

In one embodiment, the geolocation or geotemporal information can also include a time of day and/or day of the week associated with each location. In addition, the geolocation or geotemporal information can include an appropriate day of the week or month, and/or time of day, and so on, associated with each geolocation visited.

In various other embodiments, geolocation or geotemporal information is obtained from other databases related to other types of entity activity, such as one of various types of on-line social networking databases. In these embodiments, geolocation or geotemporal information is similarly obtained, which can include beacon or cell tower IDs or addresses, IP addresses, or GPS coordinates, for example. This data will contain a geolocation and a date and time of day, and can also include a period of time associated with the use at the geolocation (for example, a time span over which an entity is logged on to an activity and active). One of ordinary skill in the art will recognize that such geolocation data can be assigned to a geographical region defined by containment according to methods known in the art. For example, one-dimensional inputs (GPS coordinates) can be assigned to two-dimensional equivalents using, for example, commercially available Geographic Information System (GIS) software.

In an embodiment, all information stored in the database can be retrieved. In another embodiment, only a single entry in the database can be retrieved. The retrieval of information can be performed a single time, or can be performed multiple times.

In accordance with this disclosure, the retrieved information is analyzed to determine coincident geolocation information of entities.

In accordance with this disclosure, the coincident geolocation information of entities is analyzed to determine social relationships of the entities.

In one embodiment of a method for social network analysis using geolocation data, evidence of direct contact (indicated herein as a degree of separation of one (1)) of a first entity with a second entity who engages in fraud, for example, is used to predict the probability that the first entity will also engage in fraud.

In another embodiment of a method for social network analysis using geolocation data, a relationship weighting is assigned between two entities by analyzing the geolocation data. The relationship weighting indicates a degree of significance to the nature of relationships between entities.

For example, a frequency of recurrent geolocations involving two entities implies a deeper relationship. Recurrent geolocations during the work day indicate a different type of relationship than those made on weekends or at night. Accordingly, in one embodiment, after geolocation histories associated with the same entity are collected and combined, the geolocation history data associated with each entity is examined to calculate recurrent geolocation frequency. This data is then used to determine connections between various entities and the strength of their respective relationships.

The method of this disclosure assumes that entities will be in recurrent proximity if they have relationships. In an embodiment, it is possible (using existing technology) to identify GPS locations to specific floors of a building, which significantly increases the accuracy of the method of this disclosure.

Cohabitation and duration are embodiments for generating voting graphs and relationship graphs directly from geolocation data. It is simple to identify a relationship between two mobile phone transmitters if they are both located at the same suburban/rural address which is not a multi-family dwelling (zoning information is available from local zoning boards). The clustering of multiple co-located data points (in this case transmitters co-located while owners sleep) is known in the art of GIS software. In accordance with this embodiment, the proximity of co-located transmitters should be weighted by the amount of time that they spend in immediate proximity. Distances within the same domicile should always be considered in proximity, while outdoor distances greater than 20 feet should not be considered in proximity. It is also noted that existing GPS installations are only accurate to about a 30 foot radius, but the next generation of the service is expected to be accurate to about a 5 foot radius.

Transmission density is an embodiment in generating voting graphs and relationship graphs directly from geolocation data. If two transmitters are at the same location, but that location is frequented by many other transmitters (e.g., subway, train station, Starbucks®, etc.) then the weight of that relationship should be decreased in proportion to the number of transmitters in the vicinity. In some instances, it may be necessary to ignore all relationships identified at such locations.

A common route is an embodiment in generating voting graphs and relationship graphs directly from geolocation data. It is possible to identify relationships from transmitters that are traveling on a common route. While this method will not be effective during rush hour or along mass transit routes, it would prove very effective at identifying couples and friends on vacations or day trips together as long as the destination is not popular amongst people residing in the same area.

Once transmitter to transmitter relationships have been identified, a data structure is created whereby, in a voting graph and a relationship graph, each node corresponds to a unique transmitter and each edge corresponds to a relationship between two transmitters as described herein.

For the entities represented by nodes on the voting graph and the relationship graph, attributes associated with the relationship that describe the relationship can be defined as at least one of the geolocation of the entities, the frequency of the geolocation of the entities, the time that the entities were at the geolocation in proximity, and the duration that the entities were at the geolocation in proximity.

In an embodiment of this disclosure, a relationship weighting (e.g., vote weighting) is assigned between two entities by analyzing their geolocation data. The relationship weighting indicates a degree of significance to the nature of relationships between entities.

In an embodiment involving coincident geolocations only, a vote weight of ‘tau’ is assigned for a pair of transmitters, for each time that they are within A proximity of each other for at least time period tau. For example, if Bob stops at his friend Bill's house for an hour, this ‘coincidence’ would be assigned a weight of ‘tau’. Note that this vote assignment could occur repeatedly, if the coincidence is larger than tau. For example, if Bob is at Bill's for 4 hours and tau is 1 hour, then the vote weight would be 4 tau. In an alternative embodiment, a single vote of ‘1’ is given for each daily coincidence. These vote weights would then be summed over the defined horizon to establish a cumulative vote weighting. All cumulative vote weightings greater than the vote threshold are incorporated into the relationship graph.

In another embodiment involving coincident transactions with density adjustments, a vote weight of ‘tau/D²’ is assigned for a pair of customers, for each coincidence (where D=density). This metric would capture the frequent proximity of two transmitters, while drastically reducing the vote weights in areas such as mass transit or apartment complexes. These votes would then be summed over the defined horizon to establish a cumulative vote weighting for each edge in the vote graph. All cumulative vote weightings greater than the vote threshold are incorporated into the relationship graph.

The geolocation data is preferably filtered before forming the voting graph and the relationship graph, for example, by removing geolocations not in temporal proximity, and the like.

In accordance with this disclosure, voting graphs and relationship graphs are generated based on the coincidence of the entities. As an illustrative example of voting graphs and relationship graphs, entities cohabit in various living arrangements (e.g., marriage, roommates, etc.) or travel together (e.g., commuters, day trips, vacations, etc.). Each entity relationship (e.g., based on geolocation) can be represented using a connector (i.e., edge) in a voting graph and a relationship graph, where the entities are represented using a node in the voting graph and the relationship graph.

In an embodiment, the voting graphs and relationship graphs comprise one or more multi-node graphs having edges or connectors linking the nodes. The payment cardholders are represented by the nodes. A social relationship between the payment cardholders is represented by the edges or connectors linking the nodes. The attributes of the edges or connectors are based upon information describing a characteristic of the relationship.

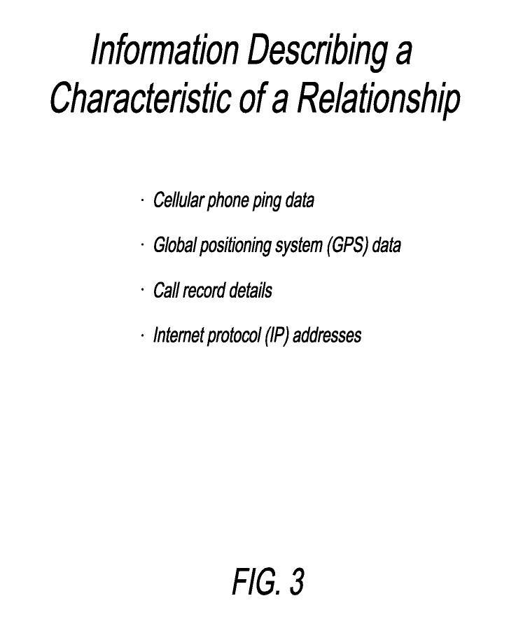

In an embodiment, the information describing a characteristic of the relationship includes cellular phone ping data, global positioning system (GPS) data, call record details, and internet protocol (IP) addresses. See FIG. 3.

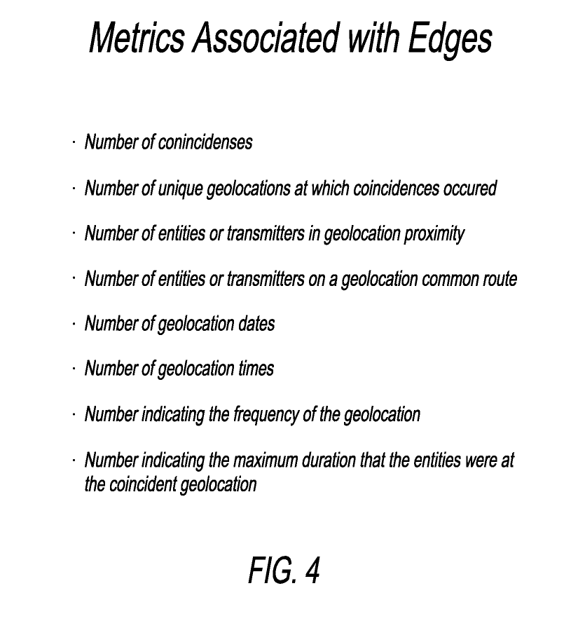

In an embodiment, an attribute of the connectors can be adjusted to represent a corresponding value of a metric. The metric can include the number of coincidences, the number of unique geolocations at which coincidences occurred, the number of entities or transmitters in geolocation proximity, the number of entities or transmitters on a geolocation common route, the number of geolocation dates on which coincidences occurred, the number of geolocation times, a number indicating the frequency of the geolocation, a number indicating the maximum duration that the entities were at the coincident geolocation, and the like. See FIG. 4.

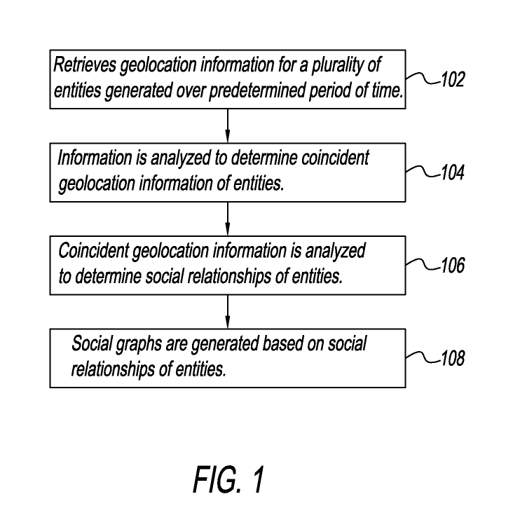

Referring to FIG. 1, the method of generating a voting graph and a relationship graph in accordance with this disclosure involves an entity retrieving information from one or more databases. The information 102 comprises geolocation data for a plurality of entities generated over a predetermined period of time. In an embodiment, from another database (not comprising a pre-constructed social graph) (e.g., payment card company), the information 102 can further comprise payment card billing, purchasing and payment transactions, and optionally financial and demographic information. The information is analyzed 104 to determine coincident geolocation information of entities. The coincident geolocation information is analyzed 106 to determine social relationships of the entities. Voting graphs and relationship graphs are generated 108 based on social relationships of the entities.

In accordance with the method of this disclosure, the voting graphs and relationship graphs are analyzed to determine behavioral information of the entities. For example, voting graphs and relationship graphs generated in accordance with the present disclosure can be analyzed in various applications, including marketing, “influencer” identification, fraud detection (e.g., bust-out fraud), crime prediction, counterterrorism, and the like.

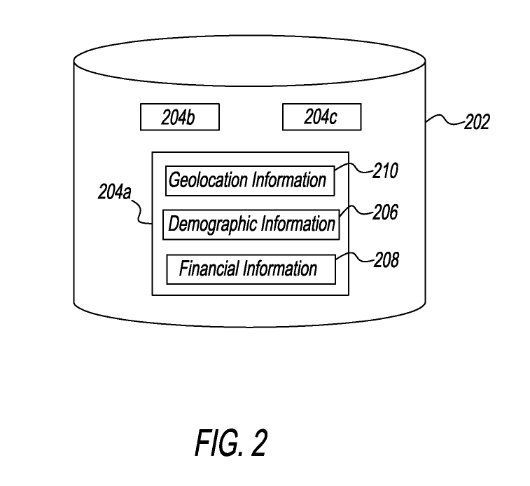

FIG. 2 illustrates an exemplary dataset 202 for the storing, reviewing, and/or analyzing of information used in generating voting and relationship graphs. The dataset 202 can contain a plurality of entries (e.g., entries 204a, 204b, and 204c).

The geolocation information 210 can contain, for example, information including cellular phone ping data, global positioning system (GPS) data, call record details, and internet protocol (IP) addresses. Financial information 208 can include any information including billing activities attributable to the financial transaction processing entity and purchasing and payment activities attributable to payment cardholders relevant to the particular application. Demographic information 206 (e.g., age and gender) can include any demographic or other suitable information relevant to the particular application.

One or more algorithms can be employed to determine formulaic descriptions of the assembly of the geolocation information and optionally financial and demographic information, using any of a variety of known mathematical techniques. These formulas, in turn, can be used to derive or generate one or more voting graphs and relationship graphs using any of a variety of available trend analysis algorithms.

Where methods described above indicate certain events occurring in certain orders, the ordering of certain events can be modified. Moreover, while a process depicted as a flowchart, block diagram, or the like can describe the operations of the present system in a sequential manner, it should be understood that many of the present system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

It should be understood that the present disclosure includes various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving, from one or more databases, information including geolocation data for a plurality of entities generated over a predetermined period of time;
analyzing the information to determine coincident geolocation information;
analyzing the coincident geolocation information to determine social relationships of the entities; and
generating one or more social graphs based on the social relationships of the entities.

2. The method of claim 1, wherein the one or more social graphs comprise one or more voting graphs and one or more relationship graphs.

3. The method of claim 1, wherein the one or more social graphs comprise one or more multi-node graphs having edges or connectors linking the nodes, and wherein the entities are represented by the nodes, and a social relationship between the entities is represented by the edges or connectors linking the nodes, wherein attributes of the edges or connectors are based upon information describing a characteristic of the relationship.

4. The method of claim 3, wherein the information describing a characteristic of the relationship includes at least one of cellular phone ping data, global positioning system (GPS) data, call record details, and internet protocol (IP) addresses.

5. The method of claim 1, wherein the edges or connectors are associated with a metric.

6. The method of claim 1, wherein the metric includes at least one of a number of coincidences, a number of unique geolocations at which coincidences occurred, a number of entities or transmitters in geolocation proximity, a number of entities or transmitters on a geolocation common route, a number of geolocation dates on which coincidences occurred, a number of geolocation times, and a number indicating the maximum duration that the entities were at the coincident geolocation.

7. The method of claim 5, wherein an attribute of the edges or connectors is adjusted to represent a corresponding value of the metric on at least one of a number of coincidences, a number of unique geolocations at which coincidences occurred, a number of entities or transmitters in geolocation proximity, a number of entities or transmitters on a geolocation common route, a number of geolocation dates on which coincidences occurred, a number of geolocation times, and a number indicating the maximum duration that the entities were at the coincident geolocation.

8. The method of claim 1, further comprising:
weighting the relationship based on at least one of a number of coincidences, a number of unique geolocations at which coincidences occurred, a number of entities or transmitters in geolocation proximity, a number of entities or transmitters on a geolocation common route, a number of geolocation dates on which coincidences occurred, a number of geolocation times, and a number indicating the duration that the entities were at the geolocation.

9. The method of claim 1, wherein the one or more social graphs comprise one or more data structures.

10. The method of claim 1, further comprising analyzing the coincident geolocation information to define social networks and relationships for predicting behaviors.

11. A social graph generated in accordance with the method of claim 1.

12. A system comprising:
one or more databases configured to store information including geolocation data for a plurality of entities generated over a predetermined period of time;
a processor configured to:
analyze the information to determine coincident geolocation information of the entities;
analyze the coincident geolocation information to determine social relationships of the entities; and
generate one or more social graphs based on the social relationships of the entities.

13. The system of claim 12 wherein the one or more social graphs comprise one or more voting graphs and one or more relationship graphs.

14. The system of claim 12, wherein the one or more social graphs comprise one or more multi-node graphs having edges or connectors linking the nodes, and wherein the entities are represented by the nodes, and a social relationship between the entities is represented by the edges or connectors linking the nodes, wherein attributes of the edges or connectors are based upon information describing a characteristic of the relationship.

15. The system of claim 14, wherein the information describing a characteristic of the relationship includes at least one of cellular phone ping data, global positioning system (GPS) data, call record details, and internet protocol (IP) addresses.

16. The system of claim 14, wherein the edges or connectors are associated with a metric.

17. The system of claim 14, wherein the metric includes at least one of a number of coincidences, a number of unique geolocations at which coincidences occurred, a number of entities or transmitters in geolocation proximity, a number of entities or transmitters on a geolocation common route, a number of geolocation dates on which coincidences occurred, a number of geolocation times, and a number indicating the maximum duration that the entities were at the coincident geolocation.

18. The system of claim 16, wherein an attribute of the edges or connectors is adjusted to represent a corresponding value of the metric on at least one of a number of coincidences, a number of unique geolocations at which coincidences occurred, a number of entities or transmitters in geolocation proximity, a number of entities or transmitters on a geolocation common route, a number of geolocation dates on which coincidences occurred, a number of geolocation times, and a number indicating the maximum duration that the entities were at the coincident geolocation.

19. The system of claim 12 wherein, the processor is configured to:
weight the relationship based on at least one of a number of coincidences, a number of unique geolocations at which coincidences occurred, a number of entities or transmitters in geolocation proximity, a number of entities or transmitters on a geolocation common route, a number of geolocation dates on which coincidences occurred, a number of geolocation times and a number indicating the duration that the entities were at the geolocation.

20. The system of claim 12, wherein the one or more social graphs comprise one or more data structures.

21. The system of claim 12, wherein the processor is further configured to analyze the coincident geolocation information to define social networks and relationships for predicting behaviors.

22. A social graph generated in accordance with the system of claim 12.
